(19) United States
(12) Patent Application Publication
(10) Pub. No.: US 2026/0112559 A1
(43) Pub. Date: Apr. 23, 2026

(54) SYSTEM AND METHOD FOR REGULATING A VOLTAGE SIGNAL

(71) Applicant: RESIDEO LLC, Golden Valley, MN (US)

(72) Inventors: Ever Adrian Hernandez, Chihuahua (MX); Rafael Aguilar, Atizapan de Zaragoza (MX); Rafael Ignacio Gonzalez, Chihuahua (MX)

(73) Assignee: RESIDEO LLC, Golden Valley, MN (US)

(21) Appl. No.: 19/116,078

(22) PCT Filed: Sep. 29, 2023
(86) PCT No.: PCT/US2023/075573

§ 371 Date: Mar. 27, 2025

Related U.S. Application Data
(60) Provisional application No. 63/377,599, filed on Sep. 29, 2022.

(51) Int. Cl. H01H 47/32; H02M 1/12; H02M 7/06

(52) U.S. Cl. CPC H01H 47/325; H02M 1/126; H02M 7/06

(57) ABSTRACT

A relay driver control system comprising: a voltage conversion unit configured to: receive and convert an AC input voltage signal to a DC voltage signal; a frequency filtering unit in electrical communication with the voltage conversion unit, the frequency filtering unit being configured to: filter out frequency components of the DC voltage signal exceeding a frequency threshold; a voltage limiting unit in electrical communication with the frequency filtering unit, the voltage limiting unit being configured to: limit the filtered DC voltage signal to voltage values not exceeding an upper voltage threshold; and a voltage monitoring unit in electrical communication with the voltage limiting unit and a relay driver, the voltage monitoring unit being configured to: generate an enabling signal based on the limited DC voltage signal; monitor the enabling signal relative to an activation threshold; and output an activation signal to the relay driver when the enabling signal meets the activation threshold.

### CROSS REFERENCE TO RELATED APPLICATIONS

This application claims the benefit of, and priority to, U.S. Provisional Ser. No. 63/377,599 filed Sep. 29, 2022, its entirety of which is incorporated herein by reference.

### FIELD OF THE DISCLOSURE

The present disclosure relates to a system and method for regulating a voltage signal, and more particularly to a system and method for regulating a voltage signal to a relay driver.

### BACKGROUND TO THE DISCLOSURE

Relays are electrically controlled devices configured to control the operation of one or more other devices by opening or closing electrical contacts of the relay. Ideally, the operating lifetime of a relay should last as long as the manufacturer of the relay indicates. However, the relay lifetime may be compromised by, for example, damage to one or more components of the relay.

Relay component damage may be caused by a switching frequency of the relay being above a preferred switching frequency. This high switching frequency may itself be caused by, for example, a control signal of the relay having a high switching frequency. Furthermore, in electromagnetic relays comprising coils, a coil voltage that is below a required operating voltage may also cause a high switching frequency.

Relay chattering (or contact chattering) may also cause component damage. Chattering may occur when, for example, a pair of contacts of the relay close and a mechanical impact causes the contacts to rebound and ‘bounce’. Chattering may also occur as a result of external forces, such as a control voltage applied to the coil. If the control voltage drops below an operational voltage, the relay may chatter. An additional external force may be a consequence of using a control switch. The control switch may intermittently cycle on and off rapidly, which may lead to the contacts chattering.

One solution to the relay component damage problem may comprise the use of a low voltage monitoring device and an input signal delaying device embedded in a microcontroller. However, such a configuration may require significant cost and development time.

Another solution may comprise adding a snubber circuit to the load connected to the relay in order to minimize energy dissipated between the relay contacts when they are switched. A disadvantage of this solution is that despite minimizing the probability of damage by electrical switching, mechanical switching is not minimized, and damage may still occur.

Another solution may comprise the use of a low voltage monitoring device and an input signal delay means using a discrete circuit having a filter to eliminate high frequency components of the control signal, and a voltage regulator to monitor and/or prevent a low voltage. Whilst being a low cost solution, this is not as flexible as other solutions in that it is difficult to add additional features to the device.

The present disclosure has been devised to mitigate at least some of the above-mentioned problems.

### SUMMARY OF THE DISCLOSURE

In accordance with a first aspect of the disclosure, there is provided a relay driver control system comprising: a voltage conversion unit configured to: receive and convert an AC input voltage signal to a DC voltage signal; a frequency filtering unit in electrical communication with the voltage conversion unit, the frequency filtering unit being configured to: filter out frequency components of the DC voltage signal exceeding a frequency threshold; a voltage limiting unit in electrical communication with the frequency filtering unit, the voltage limiting unit being configured to: limit the filtered DC voltage signal to voltage values not exceeding an upper voltage threshold; and a voltage monitoring unit in electrical communication with the voltage limiting unit and a relay driver, the voltage monitoring unit being configured to: generate an enabling signal based on the limited DC voltage signal; monitor the enabling signal relative to an activation threshold; and output an activation signal to the relay driver when the enabling signal meets the activation threshold.

The relay driver control system may provide a means for controlling (i.e. activating and/or deactivating) a relay driver to minimise chattering in a relay. The system may receive the AC input voltage signal form a voltage input device, such as a transformer. The system may output the activation signal based on a limited DC voltage, and on an enabling DC voltage which is derived from the limited DC voltage signal. The term ‘limited DC voltage signal’ may be understood as a DC voltage signal which is output from the voltage limiting unit. More particularly, the system may output the activation signal when the AC input voltage signal has been converted to a DC voltage signal with high frequency components (i.e. frequencies exceeding the frequency threshold) and high voltage values (i.e. voltage values exceeding the upper voltage threshold) removed, and when the DC voltage signal results in an enabling signal above the activation threshold.

The relay driver may activate the relay according to a DC voltage signal that is clear of high frequencies (i.e. frequencies above the frequency threshold). Advantageously, the relay driver control system may mitigate the effects of high frequency signals that may otherwise result in chattering of the relay. Furthermore, the relay driver control system may provide a means for controlling the relay driver, such that the relay driver is activated according to a voltage signal that is clear of low voltage signals (i.e. voltage signals having a voltage below the lower voltage threshold). Advantageously, by providing the activating signal when the enabling signal meets the activation threshold, the relay driver control system may mitigate the effects of low voltage signals (i.e. voltage signals that result in an enabling signal below the activation threshold) that may otherwise result in chattering of the relay. Furthermore, by limiting the filtered DC voltage signal to voltage values not exceeding an upper voltage threshold, damage to the voltage monitoring unit as a result of high or excess voltages (i.e. voltage signals having a voltage value exceeding the upper voltage threshold) may be reduced or minimised.

Preferably, the voltage monitoring unit is further configured to: monitor the enabling signal relative to a deactivation threshold; and cease outputting the activation signal to the relay driver when the enabling signal meets the deactivation threshold. The deactivation threshold may be lower than the activation threshold. In this way, the relay driver control system may cause the relay driver to deactivate (or cease activating) the relay when the enabling signal drops below the deactivation threshold. Advantageously, the relay driver control system may provide a means for activating and deactivating the relay.

Preferably, the activation threshold and the deactivation threshold form a hysteresis window. That is, the relay driver control system may output the activation signal when the enabling signal meets the activation threshold, and may maintain the activation signal even when the enabling signal falls below the activation threshold. The activation signal may be maintained until the enabling signal meets the deactivation threshold, at which point it may cease outputting the activation signal. Accordingly, the relay driver may activate the relay when the enabling signal meets the activation threshold, and deactivates the relay when the enabling signal falls below the deactivation threshold. Advantageously, the hysteresis window may mitigate chattering effects caused by a high frequency switching cycle as a result of an unstable enabling signal. That is, if the enabling signal is unstable such that it meets and falls below the activation threshold at high frequency, the hysteresis window may prevent the relay driver from activating and deactivating the relay in line with this high frequency.

In some embodiments, the activation threshold is 0.9 V. In this way the relay driver control system may output the activation signal when the enabling signal meets 0.9 V. Further activation threshold voltage values may be envisaged.

In some embodiments, the deactivation threshold is 0.4 V. In this way, the relay driver control system may cease outputting the deactivation signal when the enabling signal meets 0.4 V. In this way, the hysteresis window is 0.5 V when the activation threshold is 0.9 V. In some embodiments, the deactivation threshold comprises a value between 0.4 V to 0.9 V. Further deactivation threshold voltage values may be envisaged. It will be understood that the hysteresis window is dependent on the values of the activation threshold and the deactivation threshold.

In some embodiments, the upper voltage threshold is 30 V. In this way, the relay driver control system may advantageously limit the filtered DC voltage signal to voltage values not exceeding 30 V, such that damage to the voltage monitoring unit as a result of voltages exceeding 30 V may be reduced or minimised. In some embodiments, the upper voltage threshold comprises a value between 2.7 V to 30 V. Further upper voltage threshold voltage values may be envisaged.

Preferably, the voltage monitoring unit comprises: a voltage divider in electrical communication with the voltage limiting unit, configured to: receive the limited DC voltage signal; and output the enabling signal based on the limited DC voltage signal; and a voltage regulator in electrical communication with the voltage limiting unit and the voltage divider, configured to: receive the limited DC voltage signal and the enabling signal; and monitor the enabling signal. In this way, the voltage monitoring unit may ensure that a suitable signal is provided to the relay driver. Advantageously, undesired signals may not reach the relay driver, thus reducing the chattering effect.

In some embodiments, the voltage divider comprises a first resistor and a second resister, wherein the voltage divider is configured to provide the enabling signal as a voltage across the second resistor. In this way, the enabling signal may be dependent on a first resistance of the first resistor and a second resistance of the second resistor. Advantageously, the first and second resistances may easily be controlled, such that a voltage portion across the second resistor is more easily controlled.

In some embodiments, the voltage conversion unit comprises a rectifier. Advantageously, the voltage conversion unit may be easily implemented in a circuit. In some embodiments, the rectifier comprises a first diode; a second diode; a third diode; and a fourth diode.

In some embodiments, the frequency filtering unit comprises a capacitor. In some embodiments, the capacitor is in series with the first diode and the fourth diode. In this way, the frequency filtering unit may be easily connected to the voltage conversion unit.

In some embodiments, the frequency filtering unit is a capacitor in parallel with the voltage conversion unit.

In some embodiments, the voltage limiting unit comprises: a voltage limiting resistor; a voltage limiting Zener diode; and a transistor. Advantageously, the voltage limiting unit may be of a simple construction.

In some embodiments, a resistance of the voltage limiting resistor is pre-selected so as to limit an output voltage of the voltage limiting unit to voltage values not exceeding the upper voltage threshold.

In some embodiments, the Zener diode comprises a Zener voltage within the range of 15 V to 24 V. Further Zener voltage values may be envisaged.

In some embodiments, the transistor is a bipolar junction transistor. It will be appreciated that any suitable transistor may be utilized. The transistor may advantageously provide a more stabilised output.

In some embodiments, the frequency threshold is 50 Hz. In this way, the relay driver control system may advantageously mitigate the effects of frequency signals above 50 Hz that may otherwise result in chattering of the relay. In alternative embodiments, the frequency threshold is 60 Hz. In further alternative embodiments, the frequency threshold may comprise a value in the range of 50 Hz to 60 Hz. It will be appreciated that further frequency thresholds may be envisaged.

In accordance with a second aspect of the present disclosure, there is provided a relay driver control method comprising the steps of: receiving and converting, by a voltage conversion unit, an input AC voltage signal to a DC voltage signal; filtering out, by a frequency filtering unit, frequency components of the DC voltage signal exceeding a frequency threshold; limiting, by a voltage limiting unit, the filtered DC voltage signal to voltage values not exceeding an upper voltage threshold; generating, by a voltage monitoring unit, an enabling signal based on the limited DC voltage signal; monitoring, by the voltage monitoring unit, the enabling signal relative to an activation threshold; and outputting, by the voltage monitoring unit, an activation signal to a relay driver when the enabling signal meets the activation threshold.

In some embodiments, the method further comprises the steps of: monitoring, by the voltage monitoring unit, the enabling signal relative to a deactivation threshold; and ceasing, by the voltage monitoring unit, output of the activation signal to the relay driver when the enabling signal meets the deactivation threshold.

In some embodiments, the method further comprises the steps of: receiving, at a voltage divider in electrical communication with the voltage limiting unit, the limited DC voltage signal; and outputting, at the voltage divider, the enabling signal based on the limited DC voltage signal.

In some embodiments, the method further comprises the steps of: receiving, at a voltage regulator in electrical communication with the voltage limiting unit and the voltage divider, the limited DC voltage signal and the enabling signal; and monitoring, at the voltage regulator, the enabling signal.

In some embodiments, the method further comprises the steps of: providing, at the voltage divider, the enabling signal as a voltage across a second resistor of the voltage divider.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The disclosure will now be described by way of example only with reference to the following Figures in which:

FIG. 1A depicts a schematic view of a relay driver control system in accordance with a first aspect of the present disclosure;

FIG. 1B depicts a voltage-time graph; and

FIG. 2 shows a flow diagram of a relay driver control method in accordance with a second aspect of the present disclosure.

### DETAILED DESCRIPTION

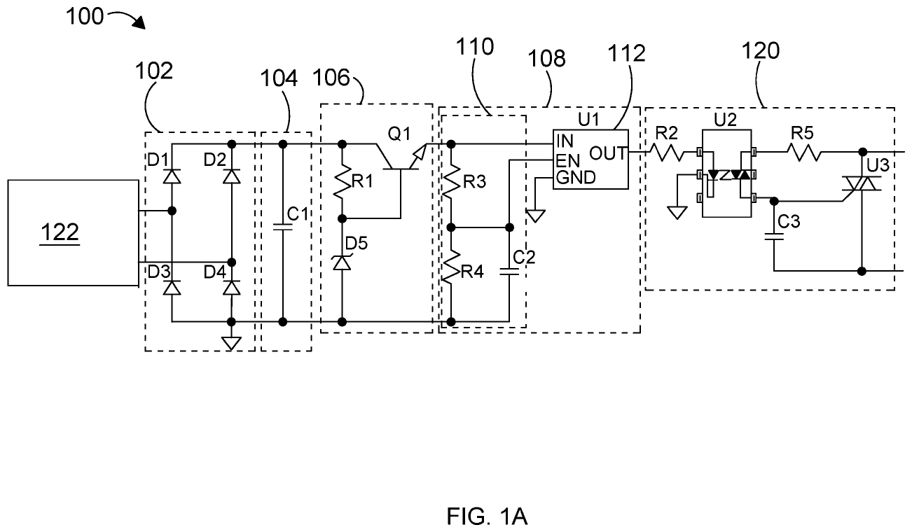

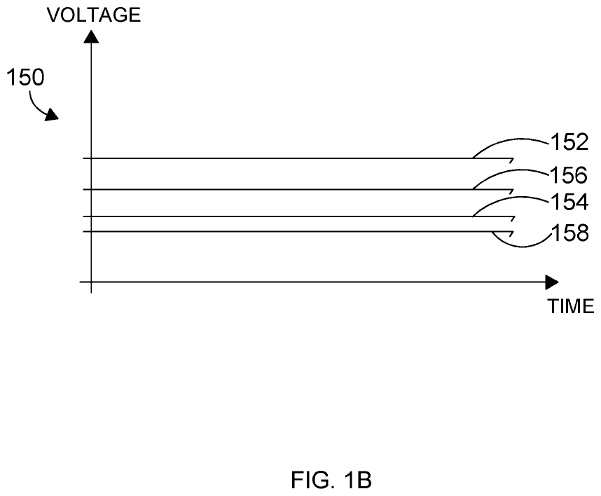

FIG. 1A depicts a schematic view of a relay driver control system 100 in accordance with a first aspect of the present disclosure. The relay driver control system 100 is configured to receive an input AC voltage signal from an external source 122. The relay driver control system 100 is also configured to control a relay driver 120.

The relay driver control system 100 is configured to reduce relay component damage of, for example, a relay coil (not shown) in communication with the relay driver 120.

The relay driver control system 100 comprises a voltage conversion unit 102; a frequency filtering unit 104; a voltage limiting unit 106; and a voltage monitoring unit 108.

The relay driver control system 100 is configured to receive the AC input voltage signal, for example from a transformer of a control unit (not shown). In the present example, the AC input voltage signal comprises a root-mean-square AC voltage of 24 VAC.

The voltage conversion unit 102 is in electrical communication with the AC input voltage signal, and is configured to receive and convert the AC input voltage signal to a DC voltage signal. The voltage conversion unit 102 comprises a rectifier 102 configured to cause current to flow in only one direction, thereby creating a direct current (DC) voltage signal. The rectifier 102 comprises: a first diode D1; a second diode D2; a third diode D3; and a fourth diode D4, such that the rectifier 102 is a full-wave rectifier 102. It will be appreciated that the voltage conversion until may utilise any suitable means for voltage conversion. In particular, other rectifiers may be used, for example a half-wave rectifier. However, a voltage ripple of the DC voltage signal may be higher if a half-wave rectifier is used, and as such a full-wave rectifier may be preferred.

The frequency filtering unit 104 is in electrical communication with the voltage conversion unit 102, and is configured to receive the DC voltage signal, and to filter out frequency components of the DC voltage signal exceeding a frequency threshold. Filtering out frequency components of the DC voltage signal exceeding the frequency threshold may mitigate chattering produced by a high frequency signal applied to a relay coil.

The frequency filtering unit 104 may comprise any suitable system, device, or apparatus capable of filtering out frequency components of the DC voltage signal exceeding the frequency threshold. In the present example, the frequency filtering unit 104 is a low-pass filter 104. The low-pass filter 104 comprises a capacitor C1 in series with the first diode D1 and the fourth diode D4. The low-pass filter 104 further comprises a resistor (not shown). In the present example, a capacitance of the capacitor C1 is 47 μF, and a resistance of the resistor is 60 Ω. However, it will be appreciated that the resistance and capacitance values may be selected so as to attenuate frequencies higher than the frequency threshold. In the present example, the frequency threshold is 50 Hz.

Accordingly, the frequency filtering unit 104 clears any high frequency DC voltage signals, thereby reducing or removing a damaging impact of such high frequency DC voltage signals on the relay coil. For example, the frequency filtering unit 104 may reduce the effects of relay coil chattering caused by high frequency components. The term “high frequency”will be understood as frequencies exceeding the frequency threshold.

The voltage limiting unit 106 is in electrical communication with the frequency filtering unit 104. The voltage limiting unit 106 is configured to receive the filtered DC voltage signal, and to limit the filtered DC voltage signal from the frequency filtering unit 104 to voltage values not exceeding an upper voltage threshold. In the present embodiment, the upper voltage threshold is 30 V.

The voltage limiting unit 106 may comprise any suitable system, device, or apparatus capable of limiting the DC voltage signal to voltage values not exceeding the upper voltage threshold. In the present example, the voltage limiting unit 106 comprises: a voltage limiting resistor R1; a voltage limiting Zener diode D5; and a transistor Q1. A resistance of the voltage limiting resistor R1 is pre-selected such that the Zener diode D5 is correctly polarized, and a base current of the transistor Q1 is sufficient to bring it into conduction. In the present example, the resistance of the voltage limiting resistor R1 is 1 kΩ. A Zener voltage of the Zener diode D5 is pre-selected so as to limit an output voltage of the voltage limiting unit 106 to voltage values not exceeding the upper voltage threshold (i.e., 30 V and below). In the present example, the Zener diode comprises a Zener voltage in the range of 15 V to 24 V. In the present example, the transistor Q1 is a bipolar junction transistor. However it will be appreciated that any suitable transistor may be used.

Accordingly, the voltage limiting unit 106 protects the voltage monitoring unit 108 from high voltages that may otherwise exceed the maximum input voltage of the voltage monitoring unit 108. The term “high voltage” will be understood as voltages exceeding the upper voltage threshold.

The voltage monitoring unit 108 is in electrical communication with the voltage limiting unit 106 and the relay driver 120. The voltage monitoring unit 108 is configured to receive the limited DC voltage signal. The voltage monitoring unit 108 is also configured to: generate an enabling signal based on the limited DC voltage signal; monitor the enabling signal relative to an activation threshold; and output an activation signal to the relay driver 120 when the enabling signal meets the activation threshold.

The voltage monitoring unit 108 may comprise any suitable system, device, or apparatus to generate an enabling signal based on the limited DC voltage signal; monitor the enabling signal relative to an activation threshold; and output an activation signal to the relay driver 120 when the enabling signal meets the activation threshold. In the present embodiment, the voltage monitoring unit 108 comprises a voltage divider 110; and a voltage regulator 112.

The voltage divider 110 is in electrical communication with the voltage limiting unit 106. The voltage divider 110 is configured to receive the limited DC voltage signal from the voltage limiting unit 106 as an input, and output the enabling signal based on the limited DC voltage signal. In particular, the voltage limiting unit 106 is configured to output an output DC voltage signal that is a fraction of the received limited DC voltage signal, the output DC voltage signal being the enabling signal. The voltage divider 110 comprises a first resistor R3 and a second resistor R4. The voltage divider 110 is configured to provide the enabling signal as the voltage across the second resistor R4. The voltage divider 110 further comprises a capacitor C2, configured to filter enabling signals having a frequency above an enabling signal frequency threshold that may otherwise cause the voltage regulator 112 to output the activation signal at an undesired time. The capacitor C2 also reduces a voltage ripple of the enabling signal.

The voltage regulator 112 is in electrical communication with the voltage limiting unit 106 and the voltage divider 110. The voltage regulator 112 is configured to receive the limited DC voltage signal from the voltage limiting unit 106 as input. The voltage regulator 112 is also configured to: receive the enabling signal from the voltage divider 110; monitor the enabling signal relative to the activation threshold; and output an activation signal to the relay driver 120 when the enabling signal meets the activation threshold. In this example, the activation threshold is 0.9 V. Accordingly, the voltage regulator 112 outputs the activation signal to the relay driver 120 when the enabling signal (i.e. the voltage across the second resistor R4) meets the activation threshold of 0.9 V. It will be appreciated that the activation threshold may be adjusted, and is dependent on the activation threshold of the voltage regulator 112.

Upon receipt of the activation signal, the relay driver 120 activates the relay.

In some embodiments, the voltage monitoring unit 108 is further configured to monitor the enabling signal relative to a deactivation threshold; and cease output of the activation signal to the relay driver 120 when the enabling signal meets the deactivation threshold. The deactivation threshold is lower than the activation threshold. In this example, the deactivation threshold is 0.4 V. It will be appreciated that the deactivation threshold may be adjustable, and is dependent on the deactivation threshold of the voltage regulator 112.

When the relay driver 120 ceases receiving the activation signal, the relay driver 120 deactivates the relay.

Accordingly, the voltage monitoring unit 108 is configured to activate the relay driver 120 by providing the activation signal whilst the enabling signal is above the deactivating threshold. The activation threshold and the deactivation threshold together form a hysteresis window, wherein a higher voltage activation threshold (e.g. 0.9 V) is required for the activation signal to be output by the voltage monitoring unit 108, whilst a lower voltage deactivation threshold (e.g. 0.4 V) is required for the voltage monitoring unit 108 to cease output of the activation signal. There therefore exists a hysteresis window between the activation threshold and the deactivation threshold, wherein, in the present example, the hysteresis window comprises a voltage range of 0.5 V (i.e. a difference between the activation threshold and the deactivation threshold). When the enabling signal comprises a voltage that meets the activation threshold, the activation signal is output by the voltage monitoring unit 108. If the voltage of the enabling signal drops below the activation threshold, the voltage monitoring unit 108 will maintain the activation signal until the voltage of the enabling signal meets the deactivation threshold, whereby the voltage monitoring unit 108 outputs the deactivation threshold.

Maintaining the activation signal when the enabling signal drops below the activation threshold and until the enabling signal meets the deactivation threshold in this way may provide a means for avoiding a high frequency switching cycle that may occur if the enabling signal is unstable.

FIG. 1B depicts a voltage-time graph 150. The graph 150 shows an input AC voltage 152; an enabling signal voltage 154; an activation threshold 156; and a deactivation threshold 158. As can be seen on the graph 150, the enabling signal voltage 154 is less than the input AC voltage 152. Also, the enabling signal voltage 154 is less than the activation threshold 156, but above the deactivation threshold 158. In situations where the enabling signal voltage 154 was above the activation threshold 156, such that the activation signal was output by the voltage monitoring unit 108, and has subsequently fallen below the activation threshold 156, the voltage monitoring unit 108 maintains the activation signal despite the enabling signal voltage 154 being below the activation threshold 156. The voltage monitoring unit 108 only ceases outputting the activation signal when the enabling signal voltage 154 meets the deactivation threshold 158. Accordingly, the hysteresis window is the gap between the activation threshold 156 and the deactivation threshold 158.

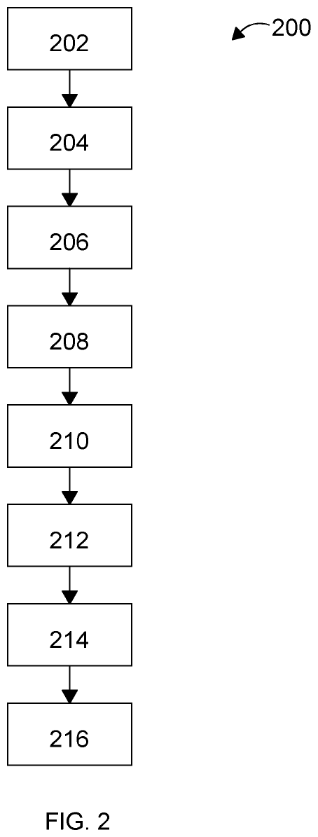

FIG. 2 shows a relay driver control method 200 using the relay driver control system 100.

At a first step 202 of the method 200, the voltage conversion unit 102 receives and converts an AC input voltage signal to a DC voltage signal.

At step 204, the frequency filtering unit 104 filters frequency components of the DC voltage signal exceeding a frequency threshold.

At step 206, the voltage limiting unit 106 limits the filtered DC voltage signal to voltage values not exceeding an upper voltage threshold.

At step 208, the voltage monitoring unit 108 generates an enabling signal based on the limited DC voltage signal. In particular, the voltage divider 110 receives the limited DC voltage signal as input, and outputs the enabling signal based on the limited DC voltage signal. The voltage divider 110 provides the enabling signal as a voltage across the second resistor R4 of the voltage divider 110.

At step 210, the voltage monitoring unit 108 monitors the enabling signal relative to an activation threshold. In particular, the voltage regulator 112 receives the enabling signal from the voltage divider 110; and monitors the enabling signal relative to the activation threshold.

At step 212, the voltage monitoring unit 108 outputs an activation signal to the relay driver 120 when the enabling signal meets the activation threshold. In particular, the voltage regulator 112 outputs the activation signal when the enabling signal meets the activation threshold.

At an optional step 214, the voltage monitoring unit 108 monitors the enabling signal relative to a deactivation threshold. In particular, the voltage regulator 112 receives the enabling signal from the voltage divider 110, and monitors the enabling signal relative to the deactivation threshold.

At an optional step 216, the voltage monitoring unit 108 ceases outputting the activation signal to the relay driver 120 when the enabling signal meets the deactivation threshold. In particular, the voltage regulator 112 ceases outputting the activation signal when the enabling signal meets the deactivation threshold.

Upon receipt of the activation signal, the relay driver 120 may activate a relay (not shown). The relay driver control system 100 and method 200 may provide a means for controlling the relay driver 120, such that the relay driver 120 is activated according to a voltage signal that is clear of low voltage signals (i.e. voltage signals having a voltage below the lower voltage threshold), and clear of high frequencies (i.e. voltage signals having a frequency above the frequency threshold). Advantageously, the relay driver control system 100 and method may mitigate the effects of high frequency signals and low voltage signals which may otherwise result in chattering of the relay.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers'specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A relay driver control system comprising:
a voltage conversion unit configured to:
receive and convert an AC input voltage signal to a DC voltage signal;
a frequency filtering unit in electrical communication with the voltage conversion unit, the frequency filtering unit being configured to:
filter out frequency components of the DC voltage signal exceeding a frequency threshold;
a voltage limiting unit in electrical communication with the frequency filtering unit, the voltage limiting unit being configured to:
limit the filtered DC voltage signal to voltage values not exceeding an upper voltage threshold; and
a voltage monitoring unit in electrical communication with the voltage limiting unit and a relay driver, the voltage monitoring unit being configured to:
generate an enabling signal based on the limited DC voltage signal;
monitor the enabling signal relative to an activation threshold; and
output an activation signal to the relay driver when the enabling signal meets the activation threshold.

2. The relay driver control system according to claim 1, wherein the voltage monitoring unit is further configured to:
monitor the enabling signal relative to a deactivation threshold; and
cease outputting the activation signal to the relay driver when the enabling signal meets the deactivation threshold.

3. The relay driver control system according to claim 2, wherein the activation threshold and the deactivation threshold form a hysteresis window.

4. A relay driver control system according to claim 2, wherein the deactivation threshold is 0.4 V.

5. A relay driver control system according to claim 1, wherein the activation threshold is 0.9 V.

6. The relay driver control system according to claim 1, wherein the upper voltage threshold is 30 V.

7. The relay driver control system according to claim 1, wherein the voltage monitoring unit comprises:
a voltage divider in electrical communication with the voltage limiting unit, configured to:
receive the limited DC voltage signal; and
output the enabling signal based on the limited DC voltage signal; and
a voltage regulator in electrical communication with the voltage limiting unit and the voltage divider, configured to:
receive the limited DC voltage signal and the enabling signal; and
monitor the enabling signal.

8. The relay driver control system according to claim 7, wherein the voltage divider comprises a first resistor and a second resister, wherein the voltage divider is configured to provide the enabling signal as a voltage across the second resistor.

9. The relay driver control system according to claim 1, wherein the voltage conversion unit comprises a rectifier.

10. The relay driver control system according to claim 9, wherein the rectifier comprises a first diode; a second diode; a third diode; and a fourth diode.

11. The relay driver control system according to claim 1, wherein the frequency filtering unit comprises a capacitor.

12. The relay driver control system according to claim 11, wherein the voltage conversion unit comprises a rectifier;
wherein the rectifier comprises a first diode; a second diode; a third diode; and a fourth diode;
wherein the capacitor is in series with the first diode and the fourth diode.

13. The relay driver control system according to claim 1, wherein the frequency filtering unit is a capacitor in parallel with the voltage conversion unit.

14. The relay driver control system according to claim 1, wherein the voltage limiting unit comprises:
a voltage limiting resistor;
a voltage limiting Zener diode; and
a transistor.

15. The relay driver control system according to claim 14, wherein a resistance of the voltage limiting resistor is pre-selected so as to limit an output voltage of the voltage limiting unit to voltage values not exceeding the upper voltage threshold.

16. The relay driver control system according to claim 14, wherein the Zener diode comprises a Zener voltage in the range of 15 V to 24 V.

17. A relay driver control system according to claim 14, wherein the transistor is a bipolar junction transistor.

18. The relay driver control system according to claim 1, wherein the frequency threshold is 50 Hz.

19. The relay driver control system according to claim 1, wherein the frequency threshold is 60 Hz.

20. A relay driver control method comprising:
receiving and converting, by a voltage conversion unit, an input AC voltage signal to a DC voltage signal;
filtering out, by a frequency filtering unit, frequency components of the DC voltage signal exceeding a frequency threshold;
limiting, by a voltage limiting unit, the filtered DC voltage signal to voltage values not exceeding an upper voltage threshold;
generating, by a voltage monitoring unit, an enabling signal based on the limited DC voltage signal;
monitoring, by the voltage monitoring unit, the enabling signal relative to an activation threshold; and
outputting, by the voltage monitoring unit, an activation signal to a relay driver when the enabling signal meets the activation threshold.

21. The relay driver control method according to claim 20, further comprising:
monitoring, by the voltage monitoring unit, the enabling signal relative to a deactivation threshold; and
ceasing, by the voltage monitoring unit, output of the activation signal to the relay driver when the enabling signal meets the deactivation threshold.

22. The relay driver control method according to claim 20, further comprising:
receiving, at a voltage divider in electrical communication with the voltage limiting unit, the limited DC voltage signal; and
outputting, at the voltage divider, the enabling signal based on the limited DC voltage signal.

23. The relay driver control method according to claim 22, further comprising:
receiving, at a voltage regulator in electrical communication with the voltage limiting unit and the voltage divider, the limited DC voltage signal and the enabling signal; and
monitoring, at the voltage regulator, the enabling signal.

24. The relay driver control method according to claim 22 further comprising:
providing, at the voltage divider, the enabling signal as a voltage across a second resistor of the voltage divider.
